(19) United States
(12) Patent Application Publication
(10) Pub. No.: US 2026/0320352 A1
(43) Pub. Date: Oct. 15, 2026

(54) NPU-Friendly Token Routing for Mixture-of-Experts Based Large Language Models on Edge Devices

(71) Applicant: MediaTek Inc., Hsinchu City (TW)

(72) Inventors: Cheng-Yu Yang, Hsinchu City (TW); Yi-Min Tsai, Hsinchu City (TW)

(21) Appl. No.: 19/557,525

(22) Filed: Mar. 5, 2026

Related U.S. Application Data
(60) Provisional application No. 63/788,853, filed on Apr. 15, 2025.

(51) Int. Cl. G06N 3/045; G06N 3/0495

(52) U.S. Cl. CPC G06N 3/045; G06N 3/0495

(57) ABSTRACT

A neural processing unit (NPU) controls the routing of input tokens to experts in a mixture-of-experts (MoE) network. The NPU generates a routing table having a batch dimension of Bs and an expert dimension of N. Each element in the routing table is a probability value of routing an input token to an expert. The NPU further generates an expert selection vector indicating K top-ranked experts for each input token by performing quantization operations and rectified linear operations on N probability values along the expert dimension of the routing table with respect to the input token. The NPU further generates N sets of one-hot expert projection vectors for respective experts based on the routing table and expert selection vectors for the Bs input tokens. The N sets of one-hot expert project vectors are used to select the input tokens to dispatch to the experts.

### CROSS-REFERENCE TO RELATED APPLICATIONS

This application claims the benefit of U.S. Provisional Application No. 63/788,853 filed on Apr. 15, 2025, the entirety of which is incorporated by reference herein.

### TECHNICAL FIELD

Embodiments of the invention relate to operations of large language models (LLMs) on a neural processing unit (NPU).

### BACKGROUND OF THE INVENTION

A mixture-of-experts (MoE) network is a neural network structure often used in a large language model (LLM). An MoE includes multiple expert networks (“experts”) specializing in different knowledge domains. The experts can be highly specialized in their designated data subspaces, making the overall model more powerful. An LLM with an MoE network can be computationally efficient as only the relevant experts are activated for each input. Moreover, the expert networks can be trained in less time to achieve a higher degree of accuracy compared to conventional models.

An MoE network includes a gating network to analyze input tokens and to decide which experts should process them. Routing tokens from the gating network to the experts involves permutation of tokens such that each expert receives only those input tokens that select the expert for processing. Although MoE can be computationally efficient, token permutation is an operation that cannot be easily performed on a neural processing unit (NPU). Adding specialized hardware for token permutation and un-permutation would increase the complexity and the cost of the NPU. Therefore, there is a need for efficient token routing methods on an NPU for MoE operations.

### SUMMARY OF THE INVENTION

In one embodiment, a method performed by an NPU is provided for controlling the routing of input tokens to experts in an MoE network. The method includes generating a routing table having a batch dimension of length Bs and an expert dimension of length N. Each element in the routing table is a probability value of routing one of Bs input tokens to one of N experts. The method further includes generating an expert selection vector indicating K top-ranked experts for each input token by performing quantization operations and rectified linear operations on N probability values along the expert dimension of the routing table with respect to the input token; generating N sets of one-hot expert projection vectors for respective experts based on the routing table and expert selection vectors for the Bs input tokens; and selecting the input tokens to dispatch to the experts using the N sets of one-hot expert project vectors.

In another embodiment, a system of an NPU is operative to control the routing of input tokens to experts in an MoE network. The system includes a memory and an accelerator coupled to the memory. The accelerator includes a quantization circuit, a rectified linear circuit, and a multiplexer circuit. The accelerator is operative to generate a routing table having a batch dimension of length Bs and an expert dimension of length N. Each element in the routing table is a probability value of routing one of Bs input tokens to one of N experts. The accelerator is further operative to generate an expert selection vector indicating K top-ranked experts for each input token by performing quantization operations and rectified linear operations on N probability values along the expert dimension of the routing table with respect to the input token; generate N sets of one-hot expert projection vectors for respective experts based on the routing table and expert selection vectors for the Bs input tokens; and select the input tokens to dispatch to the experts using the N sets of one-hot expert project vectors.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a block diagram illustrating a portion of an LLM in which a MoE network may operate according to one embodiment.

FIG. 2A and FIG. 2B illustrate a simplified example of token routing according to one embodiment.

FIG. 3 is a block diagram illustrating an NPU according to one embodiment.

FIG. 4 illustrates an example of token routing for an expert E1 according to one embodiment.

FIG. 5 illustrates an example of generating expert selections and expert projects according to one embodiment.

FIG. 6 illustrates a process for generating expert projection matrices for respective experts according to one embodiment.

FIG. 7 is a flow diagram illustrating a method of permuting and un-permuting input tokens and output tokens, respectively, by an NPU for executing an MoE network according to one embodiment.

FIG. 8 is a flow diagram illustrating a method performed by an NPU to control toking routing in an MoE network according to one embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

This disclosure describes a method and system for controlling token routing in an MoE-based LLM on an NPU. A batch of input tokens are routed to multiple expert networks (“experts”) for processing, where each input token is routed to K experts (K being a positive integer). Each expert receives a subset of the input tokens in the batch. An expert projection matrix generated for each expert describes which input tokens are to be received by that expert. The expert projection matrix is a sparse matrix composed of one-hot vectors, with each one-hot vector containing a single one and the rest are zeros. The position of the single one corresponds to the input token to be dispatched to the expert. The number of one-hot vectors in the expert project matrix is equal to the capacity of the expert, which is the maximum number of input tokens in a batch that the expert can process.

In one embodiment, the one-hot vectors can be used to control multiplexers to select input tokens for the expert. In one embodiment, the expert projection matrix can be generated using specialized hardware circuits on an NPU, such as a quantization circuit, an activation circuit, etc. The expert projection matrices for respective experts can be used to permute the input tokens. The outputs of the experts can be un-permuted according to the transpose of these expert projection matrices.

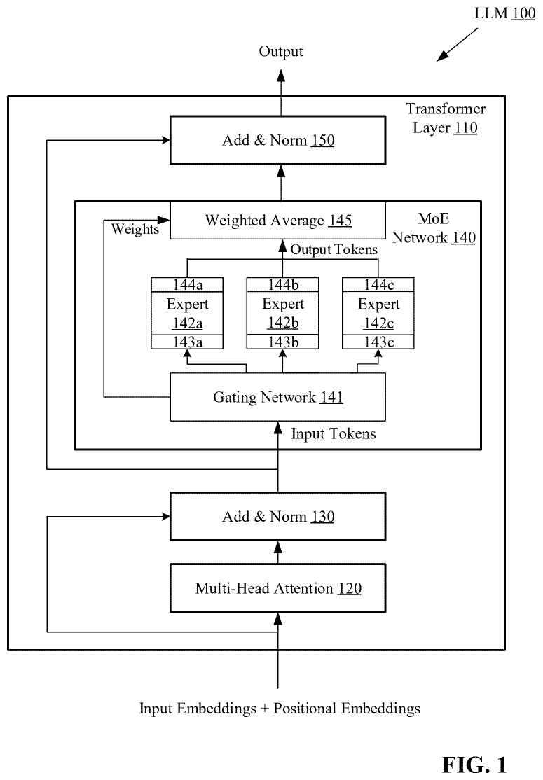

FIG. 1 is a block diagram illustrating a portion of an LLM 100 in which an MoE network may operate according to one embodiment. The LLM 100 includes a series of transformer layers, and one or more of the transformer layers include an MoE network. In one embodiment, the transformer layers may include a series of encoders and/or a series of decoders. The example of FIG. 1 shows an transformer layer 110 that includes an MoE network 140. The transformer layer 110 processes input embeddings and positional embeddings with a multi-head attention network 120 and an add-and-norm operator 130. The output of the add-and-norm operator 130 includes a batch of tokens, also referred to as input tokens or token batch. The input tokens are sent to the MoE network 140. Another add-and-norm operator 150 processes the input tokens and the output of the MoE network 140 to generate a transformer layer output. The transformer layer output may be sent to a next network (e.g., another transformer layer) in the LLM 100 for further processing.

The MoE network 140 includes a gating network 141 coupled to multiple expert networks (e.g., experts 142a, 142b, and 142c, collectively referred to as experts 142). The gating network 141 analyzes each input token and determines which expert or experts are to receive and process the input token. In one embodiment, the gating network 141 may include a fully-connected network and a softmax function. In one embodiment, the gating network 141 selects K experts to send an input token for processing. In an MoE network with N experts, the gating network 141 generates N probability values corresponding to the N experts for each input token. The experts having the K highest probability values (“K top-ranked experts”) are selected for processing the input token. In one embodiment, known machine learning algorithms may be used to calculate the probability values. According to the probability values, the gating network 141 sends the input tokens to input buffers 143a, 143b, and 143c (collectively referred to as the input buffers 143) of the respective experts 142.

In one embodiment, each expert 142 may be a feed-forward neural network. Each expert 142 receives a subset of the input tokens from its input buffer 143. Each expert 142 has a capacity (denoted as “C”), which is the upper limit on the number of input tokens that the expert 142 can process in a batch. If more than C input tokens in a batch select a given expert 142 as the recipient, the excess tokens will be dropped by that given expert 142. If less than C input tokens in a batch select a given expert 142, the expert's input buffer 143 can be zero-padded to C. The example of FIG. 1 also shows output buffers 144a, 144b, and 144c (collectively referred to as the output buffers 144) of respective experts 142 for storing respective output tokens. In one embodiment, the output tokens from the experts 142 may be weighted based on the weights generated by the gating network 141, and a weighted average operator 145 calculates a weighted average of the output tokens to generate an output of the MoE network 140.

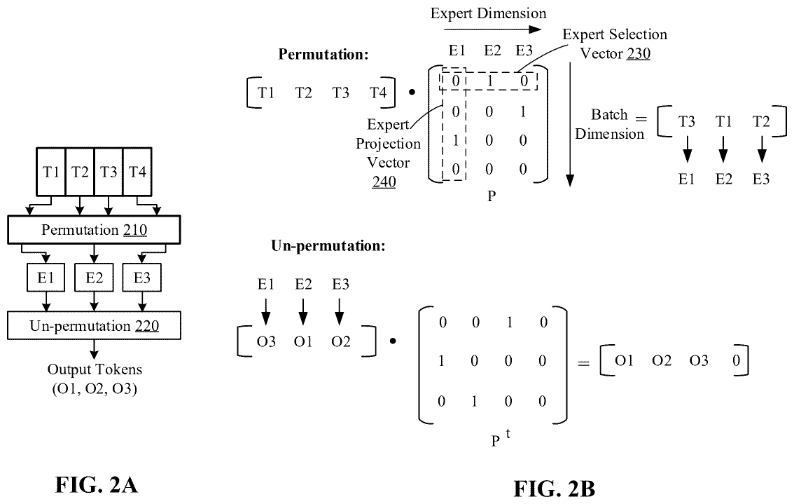

FIG. 2A and FIG. 2B illustrate a simplified example of token routing according to one embodiment. In this example, the input token batch contains four tokens T1, T2, T3, and T4. Using the example of the LLM 100 in FIG. 1, the four input tokens are sent to the MoE network 140. Based on the probability values calculated for each token, the gating network 141 determines the following assignment: T3 goes to E1, T1 goes to E2, and T2 goes to E3, where E1, E2, and E3 are the experts 142a, 142b, and 142c in FIG. 1, respectively. In this simplified example, each token is processed by one expert (i.e., K=1) and the capacity of each expert is one (i.e., C=1). Token T4 is dropped because all three experts have reached their respective capacities of one. The output tokens are O1, O2, and O3, which correspond to the input tokens T1, T2, and T3.

Referring to FIG. 2A, at an algorithmic level, the token routing at the expert input can be described by token permutation 210, and the token routing at the expert output can be described by token un-permutation 220. However, the operations of permutation 210 and the un-permutation 220 are not NPU-friendly operations. NPUs typically have a large array of multiply-accumulate (MAC) circuits and a number of specialized, fixed-function circuits. The specialized, fixed-function circuits typically do not support data permutations and un-permutations.

In one embodiment, permutation and un-permutation may be described by a matrix and its transpose, respectively. Referring to FIG. 2B, matrix P describes the permutation of the input tokens and may be used to control the routing of the input tokens to their respective experts. Matrix P is a two-dimensional matrix having an expert dimension and a batch dimension. In this example, the expert dimension is the column dimension and the batch dimension is the row dimension. That is, each column of P corresponds to one expert, and each row of P corresponds to one input token. It should be understood that the orientations of expert dimension and the token dimension may be swapped in alternative embodiments.

Each row of P is an “expert selection vector” 230, as the position of 1 in the vector 230 indicates which expert is selected to process the input token corresponding to the row. When K experts are selected to process an input token, the corresponding expert selection vector contains K numbers of 1's. Each column of P is an “expert projection vector” 240, as the position of 1 in the vector 240 indicates which input token is to be “projected” or “dispatched” to the expert corresponding to the column. When multiple input tokens are to be dispatched to an expert, multiple expert projection vectors (also referred to as an expert projection matrix) are used to describe the token routing to the expert.

FIG. 2B shows that matrix P permutes the order of the input tokens such that the multiplication of input vector [T1, T2, T3, T4] and P generates [T3, T1, T2], which is aligned with the ordering of the experts E1, E2, and E3. The outputs of experts E1, E2, and E3 are denoted as O3, O1, and O2, respectively. The output tokens O3, O1, and O2 are generated from the input tokens T3, T1, and T2, respectively. The transpose of P can be used to undo the permutation on the input tokens. The un-permutation can be described by the multiplication of [O3, O1, O2] and Pt, which generates [O1, O2, O3, 0], restoring the original ordering of the input tokens.

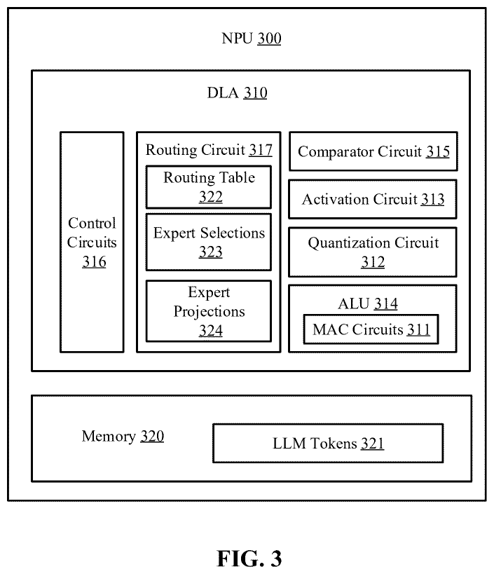

Before describing general cases in which each of K and C may be greater than 1, it is helpful to describe the hardware in an NPU. FIG. 3 is a block diagram illustrating an NPU 300 according to one embodiment. The NPU 300 includes a deep learning accelerator (DLA) 310 coupled to a memory 320 (e.g., an on-chip static random-access memory (SRAM)). The memory 320 may store LLM tokens 321. In some embodiments, the NPU 300 may include specialized function units such as a vision processing unit. The NPU 300 may operate in a computer system that also includes a central processing unit (CPU), a graphic processing unit (GPU), a digital signal processor (DSP), etc. In one embodiment, the NPU 300 may be a hardware circuit on an edge device.

In one embodiment, the DLA 310 includes, among other circuits, specialized fixed-function circuits such as a quantization circuit 312 and an activation circuit 313. The activation circuit 313 is operative to perform activation functions such as rectified linear unit (ReLU) operations, Gaussian error linear unit (GeLU) operations, and/or Sigmoid linear unit (SiLU) operations, etc. The DLA 310 further includes an arithmetic and logic unit (ALU) 314 for performing scalar operations and elementwise vector operations. Examples of the ALU 314 may include a MAC circuit 311 for performing multiply-accumulate operations, a multiplier, an adder, etc. The DLA 310 further includes a comparator circuit 315 to evaluate equal(a, b)=greater(a, (b−eps))×greater(b, (a−eps)), where eps is a small number. The DLA further includes a routing circuit 317 to perform expert selections 323 and expert projections 324 according to a routing table 322. Additional circuitry may also be included. The DLA 310 further includes control circuits 316 to control token routing.

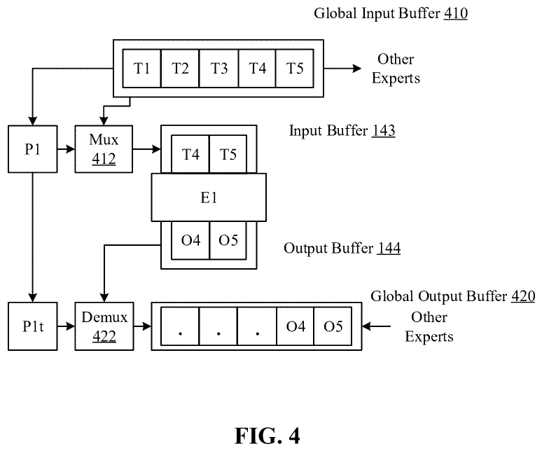

FIG. 4 illustrates an example of token routing for an expert E1 according to one embodiment. Initially, input tokens T1, T2, T3, T4, and T5 are stored in a global input buffer 410 shared by five experts E1, E2, E3, E4, and E5. The expert projection matrix P1 identifies two out of the five input tokens to be dispatched to E1 (e.g., expert capacity C=2). Matrix P1 contains C one-hot vectors, each vector identifying one of five input tokens. In one embodiment, matrix P1 can be used to control a multiplexer circuit (mux 412) to select the two input tokens for the input buffer 143 of E1. In this example, the two selected input tokens are T4 and T5. The output tokens of E1 are O4 and O5, corresponding to T4 and T5, respectively. The output tokens O4 and O5 may be temporarily stored in the output buffer 144 of E1. The transpose of matrix P1 can be used to control a demultiplexer circuit (demux 422) to select two slots in a global output buffer 420 to route the two output tokens. The following paragraphs describe a method for computing the expert projection matrix for each expert using operations supported by NPU hardware.

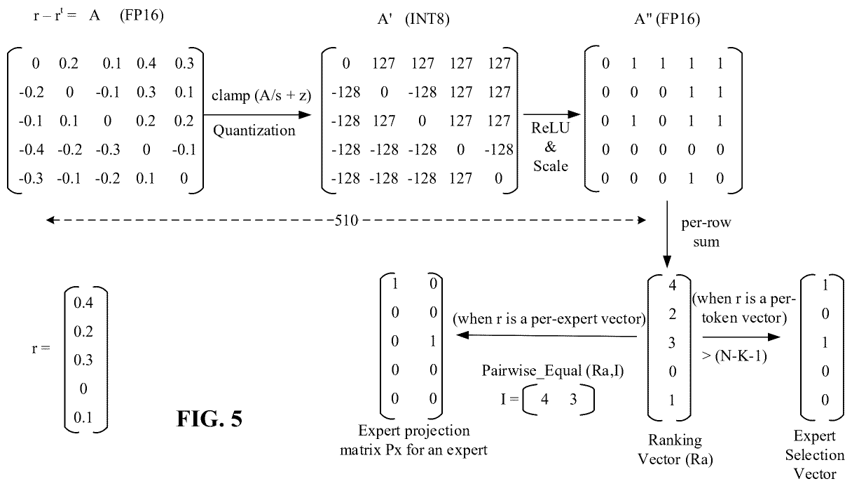

FIG. 5 illustrates an example of generating expert selections and expert projections according to one embodiment. This example also describes the calculation of a ranking vector that ranks the experts according to the respective probability values. In this example, K=2 and N=5, where N is the number of experts and K is the number of experts chosen to process a given token. The NPU 300 (FIG. 3) performs the operation of the gating network 141 to generate N probability values corresponding to the N experts with respect to each input token. The K top-ranked experts, which correspond to the K highest probability values, are chosen to process the given token.

In this example, the NPU 300 generates five probability values (e.g., 0.4, 0.2, 0.3, 0, 0.1) with respect to a given token. The five probability values correspond to experts E1, E2, E3, E4, and E5, respectively. Initially, the NPU 300 calculates a matrix A=(r−r^{t}), where r is a routing vector containing the five probability values, and each element of A is Aij, where A_ij=ri−rj (i, j are running indices from 1 to N). Matrix A has a floating-point representation (e.g., FP16). Referring also to FIG. 3, the NPU 300 uses the quantization circuit 312 to convert matrix A to matrix A′ in an integer representation (e.g., INT8). The quantization circuit 212 computes (A/s)+z, where s is a scaling factor and z is a zero point (e.g., s=E⁻⁴=0.0001, z=0). The quantization circuit 212 further clamps the result of ((A/s)+z) to the INT8 range (−128, 127) to generate A′. The NPU 300 then uses the activation circuit 313 to convert negative numbers in A′ to zero. Positive numbers (e.g., 127) in A′ stay unchanged. The NPU 300 further uses the ALU 314 (e.g., a multiplier) to scale 127 to 1 in floating-point representation, generating a matrix A″ that contains 1's and 0's only. That is, matrix A″ is the result of operations 510, which include quantization, an ReLU operation, and a scaling operation. The NPU 300 using its specialized hardware can perform quantization, ReLU, and scaling more efficiently than element-wise comparisons required by other solutions to generate matrix A″.

After matrix A″ is generated, the elements in each row of A″ are summed up to produce a ranking vector Ra of length N. Each element in Ra corresponds to one expert. The NPU 300 compares each element of Ra with (N−K−1)=(5−2−1)=2. The elements of Ra greater than (N−K−1) are set to 1 and the rest are set to 0. The resulting vector is an expert selection vector indicating the experts (e.g., E1 and E3) selected to receive the given token. The NPU 300 can compute, for all input tokens in a batch in parallel, an expert selection matrix composed of Bs expert selection vectors.

The above description of generating the ranking vector Ra starts with probability values with respect to one token. That is, Ra is a per-token vector of length N in the expert dimension (i.e., each probability value corresponds to a different expert). In another scenario, the same process of generating a ranking vector Ra may start with probability values with respect to a given expert. The resulting ranking vector Ra in this scenario is a per-expert vector of length Bs in the batch domain and can be used to generate an expert projection matrix Px for the given expert.

In this example, matrix Px is of dimensions (Bs×C), where Bs is the number of input tokens in a batch and C is the capacity of the given expert (e.g., C=2). The ranking vector Ra is in a floating-point representation. Each element of ranking vector Ra is compared with elements of an index vector I, which is formed by C of the highest-ranking values. In this example, the ranking vector Ra has Bs=5 elements, which are ranked from 0 to 4. Each of the elements is first compared with the highest-ranking value, e.g., 4. The element of Ra that is equal to 4 (or within a tolerance value (eps) of 4) is set to 1 in the corresponding position (e.g., the first element) of the first column of Px. The rest of the elements in the first column of Px are set to 0. Subsequently, each element of Ra is compared with the second highest ranking value, e.g., 3. The element of Ra that is equal to 3 (or within a tolerance value (eps) of 3) is set to 1 in the corresponding position (e.g., the third element) of the second column of S. The rest of the elements in the second column of Px are set to 0. The resulting (5×2) matrix Px is the expert projection matrix for a given expert that is chosen to receive input tokens T1 and T3.

In one embodiment, the NPU 300 evaluates the floating-point equality of two floating numbers a and b as follows: equal(a, b)=greater(a, (b−eps))×greater(b, (a−eps)). The NPU 300 includes specialized hardware (e.g., the comparator circuit 315 in FIG. 3) to evaluate the element-wise equality between Ra and I quickly and efficiently.

In one embodiment, the expert project matrix Px can be used to control the routing of input tokens to a given expert. Each vector in the batch dimension is a one-hot vector controlling the routing of one corresponding token to the given expert. The project matrix Px includes C vectors in the batch dimension, limiting the number of tokens routed to an expert to the expert's capacity C. A multiplexer (e.g., the mux 412 in FIG. 4) can select the input tokens for the expert according to the one-hot vectors. A demultiplexer (e.g., the demux 422) can place the output tokens from the expert in the correct token slots of the global output buffer 420 according to the transpose of Px.

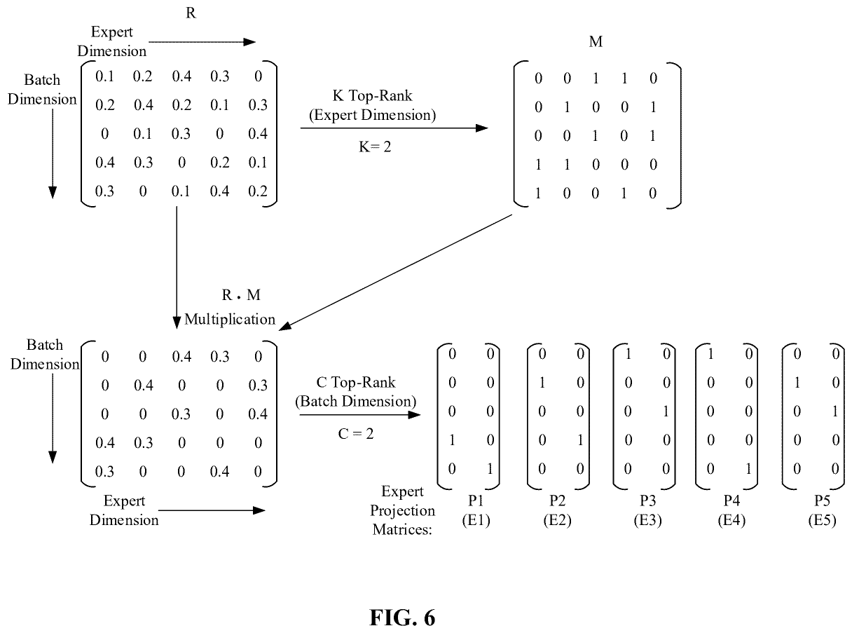

FIG. 6 illustrates a process for generating expert projection matrices for respective experts according to one embodiment. Starting from the routing matrix R on the upper left. The routing matrix R has a batch dimension of Bs and an expert dimension N, e.g., Bs=5 and N=5. In this example, the batch dimension is the row dimension, and the expert dimension is the column dimension. In an alternative embodiment, the batch dimension may be the column dimension, and the expert dimension may be the row dimension. In this example, each row of R is a routing vector calculated by the gating network 141 (FIG. 1) with respect to one input token. In one embodiment, the routing matrix R may be represented by a routing table.

By performing the operations shown in FIG. 5, the expert selection vector for the input token is generated and shown in the corresponding row of matrix M on the upper right. It is understood that the numbers presented in this example and throughout the disclosure are illustrative only. For example, the number of tokens in a batch may be greater than the number of experts.

In one embodiment, matrix M can be used as a mask on the routing matrix R. Each zero in matrix M represents a token-expert routing that does not exist. Zeroing out the corresponding elements in R can reduce the subsequent computations in generating the expert projection matrices. A masked routing matrix Rm is generated by element-wise multiplications between the corresponding elements of M and R. Each column of Rm corresponds to an expert and can be used as the vector r in FIG. 5 to calculate an expert projection matrix for the expert. Accordingly, five expert projection matrices (P1, P2, P3, P4, P5) can be generated for routing input tokens to the five corresponding experts (E1, E2, E3, E4, E5). The transposed matrices (P1^{t}, P2^{t}, P3^{t}, P4^{t}, P5^{t}) can be used at the output end of the respective experts to re-order (i.e., un-permute) the output tokens generated by the experts.

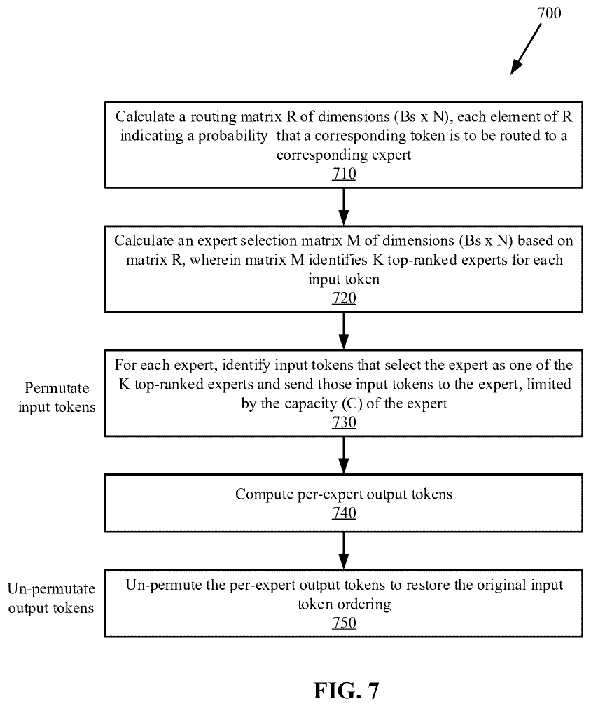

FIG. 7 is a flow diagram illustrating a method 700 of permuting and un-permuting input tokens and output tokens, respectively, by an NPU for executing an MoE network according to one embodiment. As an example, the NPU may be the NPU 300 in FIG. 3.

In one embodiment, the method 700 starts at step 710 when the NPU calculates a routing matrix R of dimensions (Bs×N). Each element of R indicates a probability that a corresponding token is to be routed to a corresponding expert. At step 720, the NPU calculates an expert selection matrix M of dimensions (Bs×N) based on matrix R. Matrix M identifies K top-ranked experts for each of the Bs input tokens. For each expert, the NPU at step 730 identifies input tokens that select the expert as one of the K top-ranked experts and sends those input tokens to the expert, limited by the capacity (C) of the expert. At step 740, the NPU computes per-expert output tokens. At step 750, the NPU un-permutes the per-expert output tokens to restore the original input token ordering.

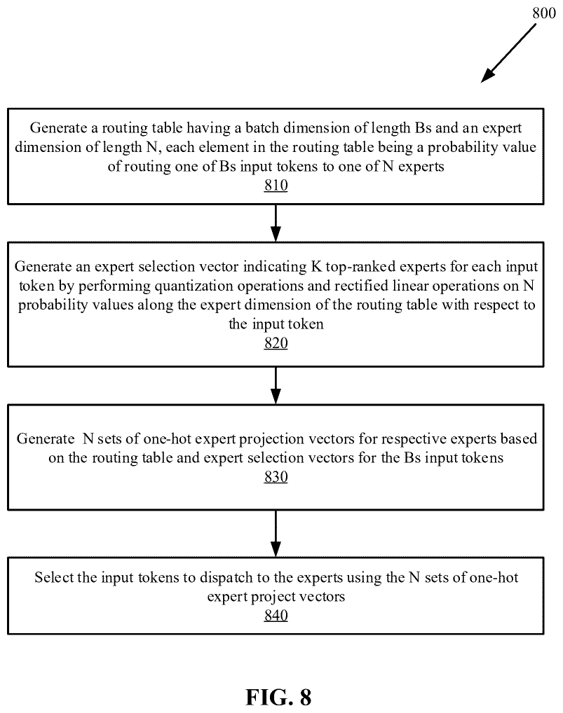

FIG. 8 is a flow diagram illustrating a method 800 performed by an NPU to control toking routing in an MoE network according to one embodiment. As an example, the NPU may be the NPU 300 in FIG. 3.

In one embodiment, the method 800 starts at step 810 with an NPU generating a routing table having a batch dimension of length Bs and an expert dimension of length N. Each element in the routing table is a probability value of routing one of Bs input tokens to one of N experts. At step 820, the NPU generates an expert selection vector indicating K top-ranked experts for each input token by performing quantization operations and rectified linear operations on N probability values along the expert dimension of the routing table with respect to the input token. At step 830, the NPU generates N sets of one-hot expert projection vectors for respective experts based on the routing table and expert selection vectors for the Bs input tokens. At step 840, the NPU selects the input tokens to dispatch to the experts using the N sets of one-hot expert project vectors.

In one embodiment, each set of one-hot expert projection vectors forms an expert projection matrix of dimensions (Bs×C), C being a capacity of a corresponding expert. The output tokens generated by the experts are routed to an output of the MoE network according to a transpose of respective expert projection matrices of the experts.

In one embodiment, when generating the expert selection of K top-ranked experts, the NPU converts the N probability values with respect to the input token to a ranking vector that ranks the experts according to respective probability values; and sets K elements of the ranking vector that correspond to the K top-ranked experts to a first value and the rest of elements of the ranking vector to a second value.

In one embodiment, when generating the expert selection of K top-ranked experts, the NPU generates a skew-symmetric matrix from the N probability values with respect to the input token; and performs the quantization operations including clamping scaled elements of the skew-symmetric matrix to an integer range. In one embodiment, the rectified linear operations include a ReLU operation.

In one embodiment, when generating the N sets of one-hot expert projection vectors, the NPU performs, for each expert, at least another quantization operation and another rectified linear operation on probability values along the batch dimension of the routing table with respect to the expert. In one embodiment, when generating the N sets of one-hot expert projection vectors, the NPU applies, to the routing table, a matrix representation of expert selections with respect to the input tokens in the batch to zero-out routing elements that represent non-existent routing between a given token and a given expert; and performs, for each expert, at least the another quantization operation and the another rectified linear operation on the probability values after zeroing-out the routing elements in the routing table.

In one embodiment, when generating each set of one-hot expert projection vectors, the NPU compares an element in a ranking vector with a ranking index to determine whether the element in the ranking vector is a top-ranked element; and sets the element to 1 when the two floating-point numbers are evaluated to be equal. In one embodiment, when selecting the input tokens, the NPU controls a multiplexer circuit in the NPU to select the input tokens for each expert using a corresponding set of one-hot expert project vectors.

The operations of the flow diagrams of FIG. 7 and FIG. 8 have been described with reference to the exemplary embodiment of FIG. 3. However, it should be understood that the operations of the flow diagrams of FIG. 7 and FIG. 8 can be performed by embodiments of the invention other than the embodiment of FIG. 3, and the embodiment of FIG. 1 can perform operations different than those discussed with reference to the flow diagrams. It is understood that the order of operations shown in the flow diagrams of FIG. 7 and FIG. 8 is a non-limiting example. Alternative embodiments may perform the operations in a different order, combine certain operations, overlap certain operations, etc.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method performed by a neural processing unit (NPU) for controlling routing of input tokens to experts in a mixture-of-experts (MoE) network, comprising:
generating a routing table having a batch dimension of length Bs and an expert dimension of length N, each element in the routing table being a probability value of routing one of Bs input tokens to one of N experts;
generating an expert selection vector indicating K top-ranked experts for each input token by performing quantization operations and rectified linear operations on N probability values along the expert dimension of the routing table with respect to the input token;
generating N sets of one-hot expert projection vectors for respective experts based on the routing table and expert selection vectors for the Bs input tokens; and
selecting the input tokens to dispatch to the experts using the N sets of one-hot expert project vectors.

2. The method of claim 1, wherein each set of one-hot expert projection vectors forms an expert projection matrix of dimensions (Bs×C), C being a capacity of a corresponding expert.

3. The method of claim 2, further comprising:
routing output tokens generated by the experts to an output of the MoE network according to a transpose of respective expert projection matrices of the experts.

4. The method of claim 1, wherein generating the expert selection of K top-ranked experts further comprises:
converting the N probability values with respect to the input token to a ranking vector that ranks the experts according to respective probability values; and
setting K elements of the ranking vector that correspond to the K top-ranked experts to a first value and rest of elements of the ranking vector to a second value.

5. The method of claim 1, wherein generating the expert selection of K top-ranked experts further comprises:
generating a skew-symmetric matrix from the N probability values with respect to the input token; and
performing the quantization operations including clamping scaled elements of the skew-symmetric matrix to an integer range.

6. The method of claim 1, wherein the rectified linear operations include a ReLU operation.

7. The method of claim 1, wherein generating the N sets of one-hot expert projection vectors further comprises:
performing, for each expert, at least another quantization operation and another rectified linear operation on probability values along the batch dimension of the routing table with respect to the expert.

8. The method of claim 1, wherein generating the N sets of one-hot expert projection vectors further comprises:
applying, to the routing table, a matrix representation of expert selections with respect to the input tokens in the batch to zero-out routing elements that represent non-existent routing between a given token and a given expert; and
performing, for each expert, at least the another quantization operation and the another rectified linear operation on the probability values after zeroing-out the routing elements in the routing table.

9. The method of claim 1, wherein generating each set of one-hot expert projection vectors further comprises:
comparing two numbers including an element in a ranking vector and a ranking index to determine whether the element in the ranking vector is a top-ranked element; and
setting the element to 1 when the two numbers are evaluated to be equal.

10. The method of claim 1, wherein selecting the input tokens further comprises:
controlling a multiplexer circuit in the NPU to select the input tokens for each expert using a corresponding set of one-hot expert project vectors.

11. A system of a neural processing unit (NPU) operative to control routing of input tokens to experts in a mixture-of-experts (MoE) network, comprising:
a memory; and
an accelerator coupled to the memory, the accelerator including a quantization circuit, a rectified linear circuit, and a multiplexer circuit, the accelerator operative to:
generate a routing table having a batch dimension of length Bs and an expert dimension of length N, each element in the routing table being a probability value of routing one of Bs input tokens to one of N experts;
generate an expert selection vector indicating K top-ranked experts for each input token by performing quantization operations and rectified linear operations on N probability values along the expert dimension of the routing table with respect to the input token;
generate N sets of one-hot expert projection vectors for respective experts based on the routing table and expert selection vectors for the Bs input tokens; and
select the input tokens to dispatch to the experts using the N sets of one-hot expert project vectors.

12. The system of claim 11, wherein each set of one-hot expert projection vectors forms an expert projection matrix of dimensions (Bs×C), C being a capacity of a corresponding expert.

13. The system of claim 12, wherein the accelerator is further operative to:
route output tokens generated by the experts to an output of the MoE network according to a transpose of respective expert projection matrices of the experts.

14. The system of claim 11, wherein, when generating the expert selection of K top-ranked experts, the accelerator is further operative to:
convert the N probability values with respect to the input token to a ranking vector that ranks the experts according to respective probability values; and
set K elements of the ranking vector that correspond to the K top-ranked experts to a first value and rest of elements of the ranking vector to a second value.

15. The system of claim 11, wherein, when generating the expert selection of K top-ranked experts, the accelerator is further operative to:
generate a skew-symmetric matrix from the N probability values with respect to the input token; and
perform the quantization operations including clamping scaled elements of the skew-symmetric matrix to an integer range.

16. The system of claim 11, wherein the rectified linear operations include a ReLU operation.

17. The system of claim 11, wherein, when generating the N sets of one-hot expert projection vectors, the accelerator is further operative to:
perform, for each expert, at least another quantization operation and another rectified linear operation on probability values along the batch dimension of the routing table with respect to the expert.

18. The system of claim 11, wherein, when generating the N sets of one-hot expert projection vectors, the accelerator is further operative to:
apply, to the routing table, a matrix representation of expert selections with respect to the input tokens in the batch to zero-out routing elements that represent non-existent routing between a given token and a given expert; and
perform, for each expert, at least the another quantization operation and the another rectified linear operation on the probability values after zeroing-out the routing elements in the routing table.

19. The system of claim 11, wherein, when generating each set of one-hot expert projection vectors, the accelerator is further operative to:
compare two numbers including an element in a ranking vector and a ranking index to determine whether the element in the ranking vector is a top-ranked element; and
set the element to 1 when the two numbers are evaluated to be equal.

20. The system of claim 11, wherein, when selecting the input tokens, the accelerator is further operative to:
control a multiplexer circuit in the NPU to select the input tokens for each expert using a corresponding set of one-hot expert project vectors.
